(19) United States
(12) Patent Application Publication
(10) Pub. No.: US 2012/0253537 A1
(43) Pub. Date: Oct. 4, 2012

(54) POWER SUPPLY METHOD, RECORDING MEDIUM WHICH IS COMPUTER READABLE AND POWER GENERATION SYSTEM

(75) Inventors: Hiroyuki OKUDA, Moriguchi-shi (JP); Atsuhiro Funahashi, Moriguchi-shi (JP); Yoshito Kaga, Moriguchi-shi (JP); Takeshi Nakashima, Moriguchi-shi (JP); Souichi Sakai, Moriguchi-shi (JP); Ryuzo Hagihara, Moriguchi-shi (JP)

(73) Assignee: Sanyo Electric Co., Ltd, Moriguchi-shi (JP)

(21) Appl. No.: 13/415,273

(22) Filed: Mar. 8, 2012

Related U.S. Application Data
(63) Continuation of application No. PCT/JP2010/073113, filed on Dec. 22, 2010.

(30) Foreign Application Priority Data
Dec. 22, 2009 (JP) 2009-290342

(51) Int. Cl. G05F 1/66

(52) U.S. Cl. 700/296

(57) ABSTRACT

The method of controlling a power generator generating electric power using renewable energy and a battery storing electric power generated by the power generator, comprising: acquiring data on an amount of electric power generated by the power generator at predetermined time intervals over a sampling period, the data being acquired as electric signals; computing a target output value for the electric power to be supplied to an electric power transmission system based on the data on the amount of electric power generated by the power generator; supplying to the electric power transmission system electric power equal to the target output value from at least one of the power generator and the battery; determining a fading condition of the battery; and varying the sampling period in accordance with the fading condition of the battery.

### TECHNICAL FIELD

This application is a continuation of International Application No. PCT/JP2010/073113, filed Dec. 22, 2010, which claims priority from Japanese Patent Application No. 2009-290342, filed Dec. 22, 2009, the entire contents of which are incorporated herein by reference.

The present invention relates to a power supply method, a recording medium which is readable by a computer and a power generation system.

In recent years the number of instances where electricity consumers (e.g. domestic houses or factories and the like) in receipt of the supply of alternating current from substations are supplied with power generators utilizing natural energy such as wind power and sunlight (solar cells) is increasing. These types of power generators are connected to the power grid subordinated to the substation, and power generated by the power generators is output to the power consuming devices side of the consumer location. The superfluous electric power, which is not consumed by the power consuming devices in the consumer location, is output to the power grid. The flow of this power towards the power grid from the consumer location is termed “counter-current flow”, and the power output from the consumer to the power grid is termed “counter-current power”.

In this situation the power suppliers such as the power companies and the like have a duty to ensure the stable supply of electric power and need to maintain the stability of the frequency and voltage of the overall power grid, including the counter-current power components. For example, the power supply companies maintain the stability of the frequency of the overall power grid by a variety of method in correspondence with the size of the variable period. Specifically, in general, in respect of a load component with a variable period of some tens of minutes, economic dispatching control (EDC) is performed to enable output sharing of the power output in the most economic manner. This EDC is controlled based on the daily load fluctuation expectation, and it is difficult to respond to the increases and decreases in the load fluctuation from minute to minute and second to second (the components of the fluctuation period which are less than some tens of minutes). In that instance, the power companies adjust the amount of power supplied to the power grid in correspondence with the minute fluctuations in the load, and perform plural controls in order to stabilize the frequency. Other than the EDC, these controls are called frequency controls, in particular, and the adjustments of the load fluctuation components not enabled by the adjustments of the EDC are enabled by these frequency controls.

More specifically, for the components with a fluctuation period of less than approximately 10 seconds, their absorption is enabled naturally by means of the auto-control function of the power grid itself. Moreover, for the components with a fluctuation period of less than 10 seconds to the order of several minutes, they can be dealt with by the governor-free operation of the power generator in each generating station. Furthermore, for the components with a fluctuation period of the order of several minutes to tens of minutes, they can be dealt-with by load frequency control (LFC). In this load frequency control, the frequency control is performed by the adjustment of the power output of the generating station for LFC by a control signal from the central power supply command station of the power supplier.

However, the output power of power generators utilizing natural energy may vary abruptly in correspondence with the weather and such like. This abrupt fluctuation in the power output of this type of power generator applies a gross adverse impact on the degree of stability of the frequency of the power grid they are connected to. This adverse impact becomes more pronounced as the number of consumers with power generators using natural energy increases. As a result, in the event that the number of consumers with power generators utilizing natural energy increases even further henceforth, there will be a need arising for sustenance of the stability of the power grid by the control of the abrupt fluctuation in the output of the power generator.

In relation to that, there have been proposals, conventionally, to provide the electricity generation systems with batteries to enable the storage of power resulting from the power output by power generators, in addition to the generator utilizing natural energy, in order to control the abrupt fluctuation in the power output of these types of power generators. Such a power generation system was disclosed, for example, in Japanese laid-open patent publication No. H2008-48544.

In Japanese laid-open patent publication No. H2008-48544, a solar power generation system is disclosed which is provided with a solar cell, a battery cells which enable the storage of the power output of the solar cells, and a converter which is connected to the power grid, and not only converts the direct current from the solar cell and the battery cells to alternating current, but outputs the power converted to alternating current to the power grid. In the patent publication, the fluctuation in the power output from the converters is suppressed by controlling the charging and discharging of the battery cells in accordance with the fluctuation in the power output by the solar cell. By this means, because the control of the fluctuation in the power output to the power grid is enabled, the adverse impact on the frequency of the power grid can be suppressed. Moreover, the solar power generation system enabled in the patent publication is configured to enable recognition of a fading condition of the battery cells. Moreover, in the solar power generation system enabled in the patent publication, even in the event that the battery cells are faded, the sustenance of the control on the fluctuation in the power output to the power grid is enabled by employing the battery cells which are faded over a total range from the upper limit value to the lower limit value of the voltage of the battery cells.

### PRIOR ART TECHNOLOGY REFERENCES

### Patent References

Patent Reference No. 1: Japanese laid-open patent publication No. H2008-48544.

### Problems to be Solved by the Invention

In the patent publication, even in the event that the battery cells are faded, because the sustenance of the control on the fluctuation in the power output to the power grid is enabled by employing the battery cells which are faded over a total range from the upper limit value to the lower limit value of the voltage of the battery cells, there is the disadvantage that the faded battery cells are faded abruptly even further. As a result, there is the problem that the lifetime of the battery comprised of the battery cells become shorter.

### SUMMARY OF THE INVENTION

The method of controlling a power generator generating electric power using renewable energy and a battery storing electric power generated by the power generator, comprising: acquiring data on an amount of electric power generated by the power generator at predetermined time intervals over a sampling period, the data being acquired as electric signals; computing a target output value for the electric power to be supplied to an electric power transmission system based on the data on the amount of electric power generated by the power generator; supplying to the electric power transmission system electric power equal to the target output value from at least one of the power generator and the battery; determining a fading condition of the battery; and varying the sampling period in accordance with the fading condition of the battery.

The computer-readable recording medium which records a control program for causing one or more computers to perform the steps comprising: acquiring data on an amount of electric power generated by a power generator at predetermined time intervals over a sampling period; computing a target output value for the electric power to be supplied to an electric power transmission system based on the data on the amount of electric power generated by the power generator; supplying to the electric power transmission system electric power equal to the target output value from at least one of the power generator and a battery storing electric power generated by the power generator; determining a fading condition of the battery; and varying the sampling period in accordance with the fading condition of the battery.

An electric power generation system, comprising: a power generator configured to generate electric power using renewable energy;

a battery configured to store electric power generated by the power generator; and

a controller configured such that electric power is supplied to an electric power transmission system from at least one of the power generator and the battery, to compute a target output value for the electric power to be supplied to the electric power transmission system based on data on an amount of power generated by the power generator over a sampling period, to determine a fading condition of the battery, and to modify the sampling period in accordance with the determined fading condition.

The electric power generation system, comprising: a power generator configured to generate electric power using renewable energy; a battery configured to store electric power generated by the power generator; and a supply section configured to supply electric power to an electric power transmission system from at least one of the power generator and the battery; a commutation section configured to compute a target output value for the electric power to be supplied through the supply section to the electric power transmission system based on data on an amount of power generated by the power generator over a sampling period; and a sample period modification section configured to modify the sampling period based on a fading condition of the battery.

The device controlling a power generator generating electric power using renewable energy and a battery storing electric power generated by the power generator, comprising: a data acquisition part configured to acquire data on an amount of electric power generated by the power generator at predetermined time intervals over a sampling period; a computation part configured to compute a target output value for the electric power to be supplied to an electric power transmission system based on the data on the amount of electric power generated by the power generator; a sample period modification part configured to modify the sampling period based on a fading condition of the battery; and a supply control part configured to have at least one of the power generator and the battery supply electric power equal to the target output to the electric power transmission system.

### BRIEF DESCRIPTION OF THE DRAWINGS

FIG. 1 shows a block diagram of the configuration of the power generation system of the present invention.

FIG. 2 shows a graph in order to explain the determination of the fading condition of the battery based on the discharge capacity ratio and the charge capacity ratio in the power generation system of the present invention.

FIG. 3 shows a graph in order to explain the determination of the fading condition for the battery performed based on the internal resistance of the battery cells in the power generation system of the present invention.

FIG. 4 shows a graph in order to explain the determination of the fading condition for the battery performed based on the usage duration of the battery cells in the power generation system of the present invention.

FIG. 5 shows a drawing in order to explain the computational method for the target output value in the beginning of the battery lifetime of the battery of the power generation system of the present invention.

FIG. 6 shows a drawing in order to explain the relationship of the intensity of the load fluctuation of the output to the power grid, and the fluctuation period.

FIG. 7 shows a flow chart in order to explain the control flow on the occasion of the determination of the rate of progression of the fading condition of the battery of the power generation system of the present invention.

FIG. 8 is a graph derived by a simulation of the time fluctuation trends of the power output which is output from the power generator of the power generation system of the present invention, and the time fluctuation trends of the power output from the supply section when charging and discharging control is performed in respect of the power output by the power generator.

FIG. 9 shows a graph derived as a result of a simulation of the time fluctuation trends of the battery output which is output from the battery cells of the power generation system of the present invention.

FIG. 10 shows a graph derived as a result of a simulation of the time fluctuation trends of the battery cell capacity of the battery cells of the power generation system of the present invention.

FIG. 11 is a drawing in order to explain the reduction in the capacity of the battery cell in use as the battery lifetime progresses from the beginning to the end of the battery lifetime.

FIG. 12 is a drawing in order to explain the sampling periods during the charge and discharge control. FIG. 13 shows a graph of the plural stages of the reduction of the sampling period in accordance with the fading condition of the battery in a modified embodiment of the power generation system of the present invention.

FIG. 14 shows a graph of the linear reduction in the sampling periods in accordance with the fading condition of the battery in a modified embodiment of the power generation system of the present invention.

Hereafter, the embodiments of the present invention are explained based on the figures.

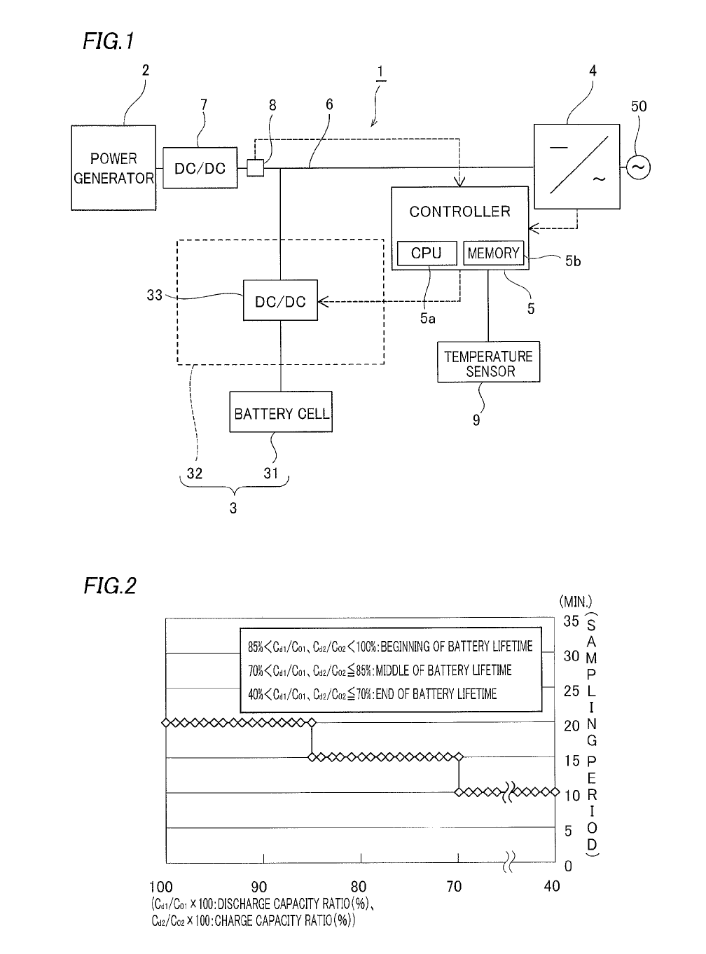

Firstly, the configuration of the power generation system 1 of the first embodiment of the present invention is explained while referring to FIG. 1 and FIG. 2.

The power generation system 1 has the power generator 2 comprised of a solar cell employing sunlight, connected to the power grid 50. The power generation system 1 provides the battery 3 enabling electrical storage of the power generated by the power generator 2, and the supply section 4 including an inverter which outputs electrical power stored by the battery 3 as well as power generated by the power generator 2, and the charge and discharge controller 5 controlling the charging and discharging of the battery 3. Now, the power generator 2 is preferably a generator utilizing renewable energy and, for example, may employ a wind power generator and the like.

The DC-DC converter 7 is connected in series on the bus 6 connecting the power generator 2 and the supply section 4. The DC-DC converter 7 converts the direct current voltage of the power generated by the power generator 2 to a fixed direct current voltage (In this embodiment, approximately 260 V) and outputs to the supply section 4 side. Moreover, the DC-DC converter 7 has a so-called a maximum power point tracking (MPPT) control function. The MPPT function is a function where by the operating voltage of the power generator 2 is automatically adjusted to be maximized in the power output by the power generator 2. A diode is provided (not shown in the figures) between the power generator 2 and the DC-DC converter 7 so as to prevent the reverse flow of the current to the power generator 2.

The battery 3 includes the battery cell 31 connected in parallel with the bus 6, and the charge and discharge means 32 which performs the charge and discharge of the battery cell 31. As the battery cell 31, a high charge and discharge efficiency ratio rechargeable battery with low natural discharge (e.g. a lithium ion battery cell, a Ni—MH battery cell and the like) are employed. Moreover, the voltage of the battery cell 31 is approximately 48 V.

The charge and discharge means 32 has a DC-DC converter 33, and the bus 6 and the battery cell 31 are connected via the DC-DC converter 33. When charging, the DC-DC converter 33 supplies electrical power from the bus 6 side to the battery cell 31 side by reducing the voltage of the bus 6 to a voltage suitable for charging the battery cell 31. Moreover, when discharging, the DC-DC converter 33 discharges the electrical power from the battery cell 31 side to the bus 6 side by raising the voltage from the voltage of the battery cell 31 to the vicinity of the voltage of the bus 6 side.

The controller 5 includes CPU 5a and memory 5b, and performs the control of the charge and discharge of the battery cell 31 by controlling the DC-DC converter 33. The charge and discharge control of the battery cell 31 is performed by the control program recorded in the memory 5b of the CPU 5a. Now the control program is recorded in a recording media which is computer readable. The control program read-out from the recording media is installed in the memory 5b of the controller 5.

In this embodiment, a target output value is set for output to the power grid 50, in order to smooth the power value output to the power grid 50, irrespective of the power output by the power generator 2. The controller 5, controls the amount of the charge and discharge of the battery cell 31, in order that the amount of power output to the power grid 50 becomes the target output value, in accordance with the power output by the power generator 2. In other words, when the power output by the power generator 2 is in excess of the target output value, the controller 5 not only controls the DC-DC converter 33 in order to charge the battery cell 31 using the excess power, but also when the power output by the power generator 2 is less than the target output value, the controller 5 controls the DC-DC converter 33 in order to discharge the shortfall in power from the battery cell 31.

The target output value is computed using the moving average method. The moving average method is a computation method for the target output value for a point in time, wherein the average value for the power output by the power generator 2 in a period from the point in time back to the past is computed. In order to compute the target output value, the controller 5 acquires the power output data by the power generator 2 for every specific detection time interval in a specific detection period from the detector 8 provided on the output side of the DC-DC converter 7. The detector 8 detects the power output by the power generator 2 and sends the power output data to the controller 5.

The specific detection period (Hereafter referred to as the ‘sampling period’) is preferably a period between the fluctuation periods T1 (approximately 2 minutes) and T2 (approximately 20 minutes) in correspondence with the load frequency control (LFC), preferably greater than the lower limit period T1 and not a period which is not too long, but nearer to T2. The specific detection time interval should be such as to be shorter than the fluctuation period to correspond to the load frequency control (LFC), and in this embodiment, is set at 30 seconds (0.5 minutes). Now, because the detection time interval cannot accurately detect the fluctuation in the amount of power generated when either too long or too short, it should be set to an appropriate value in consideration of the fluctuation period of the power output by the power generator 2.

Moreover, the controller 5 determines the fading condition of the battery 3, and varies the sampling period based on the determined result. When the sampling period is set longer then more the power output data can be acquired, and because the computation of an appropriate target output value is thus enabled, it is preferable in order to suppress the adverse impact on the power grid of fluctuation in the power output by the power generator 2. However, when the sampling period is set to be long, there is a strong possibility that the amount of fluctuation in the amount of power generated will be high. Because the capacity of the battery cell 31 becomes less at the end of the battery lifetime thereof, when the amount of fluctuation in the power output by the power generator 2 becomes great, there is the possibility that the target output value cannot be delivered. Because of this, when the deterioration of the battery cell 31 progresses in this embodiment, the sampling period is made shorter, and the amount of fluctuation in the power output by the power generator 2 is lessened. In relation to the determination method of the deterioration in the condition of the battery 3, and the method of modifying the sampling period, they are described later.

Moreover, the controller 5 acquires the power output of the supply section 4 and established the difference between the power output to the power grid 50 from supply section 4, and the target output value. By this means, feedback control on the electrical charging and discharging of the charging and discharging means 32 is enabled in order to ensure that the power output from the supply section 4 meets the target output value.

Furthermore, the controller 5 is connected to a temperature sensor 9. The internal resistance value of the battery cell 31 which is described later is computed based on the detected temperature by the temperature sensor 9 in the controller 5.

Next, the control method of the sampling period of the power output data by the controller 5 is explained while referring to FIG. 1 and FIG. 2.

As shown in FIG. 2, the controller 5 varies the sampling period in three levels, stepwise, in accordance with the degree of progression of the fading condition of the battery cell 31 of the battery 3.

Specifically, in the beginning of the battery lifetime when the time from when the charging and discharging of the battery cell 31 of the battery 3 began is short (e.g. in the period of 0˜3 years of usage), the sampling period is set to be 20 minutes. In other words, the controller 5 acquires the mean value of 40 power output data samples previously (20 minutes/0.5 min.=40).

Moreover, in the middle of the battery lifetime when some time from when the charging and discharging of the battery cell 31 of the battery 3 began has elapsed (e.g. in the period of 3˜6 years of usage), the sampling period is set to be 15 minutes. In other words, the controller 5 acquires the mean value of 30 power output data samples.

Moreover, in the end of the battery lifetime when the time from the charging and discharging of the battery cell 31 of the battery 3 began is long (e.g. in the period of 6˜10 years of usage), the sampling period is set to be 10 minutes. In other words, the controller 5 acquires the mean value of 20 power output data samples.

Here, the determination method of the deterioration state of the battery cell 31 of the battery 3 is explained.

Firstly, in the power generation system 1, the controller 5 measures the charge capacity and the discharge capacity of the battery cell 31 by discharging the battery cell 31 to a charge level of 0, as well as charging until the degree of charging is maximum (100%) in a specific period (for example, in a 30 day period). By this means, the controller 5 acquires the discharge capacity C_{d1} and the charge capacity C_{d2} of the battery cell 31 in a specific period. Now the discharge capacity C_{d1} and the charge capacity C_{d2} are one embodiment of the “First capacity value” of the present invention.

Furthermore, the controller 5 had already measured the discharge capacity C₀₁ and the charge capacity C₀₂ of the battery cell 31 of the battery 3 of the power generation system 1 before the use thereof was initiated. Then, the controller 5 not only performs the computation of the ratio of the discharge capacity ratio C_{d1}/C₀₁ of the battery cell, based on the discharge capacity C_{d1} and the charge capacity C₀₁, the computation of the ratio of the charge capacity ratio C_{d2}/C₀₂ of the battery cell, based on the charge capacity C_{d2} and the charge capacity C₀₂, is also performed. Now the ratio of the discharge capacity C₀₁ and the charge capacity C₀₂ are embodiments of the “Second capacity value” of the present invention.

Then, the controller 5 performs a determination of the degree of progress of the deterioration condition of the battery cell 31 based on the discharge capacity ratio C_{d1}/C₀₁ and the charge capacity ratio C_{d2}/C₀₂ of the battery cell 31.

Specifically, as shown in FIG. 2, when the discharge capacity ratio C_{d1}/C₀₁ and the charge capacity ratio C_{d2}/C₀₂ of the battery cell 31 are greater than 0.85 (85%) and less than 1.0 (100%), the controller 5 determines that the degree of the progression of the deterioration condition of the battery cell 31 is in the beginning of the battery lifetime.

When the discharge capacity ratio C_{d1}/C₀₁ and the charge capacity ratio C_{d2}/C₀₂ of the battery cell 31 are greater than 0.70 (70%) and less than 0.85 (85%), the controller 5 determines that the degree of the progression of the deterioration condition of the battery cell 31 is in the middle of the battery lifetime.

When the discharge capacity ratio C_{d1}/C₀₁ and the charge capacity ratio C_{d2}/C₀₂ of the battery cell 31 are greater than 0.40 (40%) and less than 0.70 (70%), the controller 5 determines that the degree of the progression of the fading condition of the battery cell 31 is in the end of the battery lifetime.

Moreover, when the controller 5 determines that the discharge capacity ratio C_{d1}/C₀₁ and the charge capacity ratio C_{d2}/C₀₂ of the battery cell 31 are abnormal values, the degree of progression of the fading condition of the batter cell 31 is determined by the computation of the later described internal resistance value of the batter cell 31. Specifically, when the discharge capacity ratio C_{d1}/C₀₁ and the charge capacity ratio C_{d2}/C₀₂ of the battery cell 31 are less than 0.40 (40%), and when over 1.0 (100%), the electrical charge and discharge control means 5 determines that the discharge capacity ratio C_{d1}/C₀₁ and the charge capacity ratio C_{d2}/C₀₂ of the battery cell 31 are abnormal values.

When the controller 5 determines that the discharge capacity ratio C_{d1}/C₀₁ and the charge capacity ratio C_{d2}/C₀₂ of the battery cell 31 are abnormal values, the controller 5 computes the internal resistance R₂₀ of the battery cell 31 of the battery 3 at 20° C. Specifically, the controller 5 measures the mean voltage value V for the battery cell 31 when the degree of charging is varied between 0 and maximum (100%), and the mean current value I. Moreover, the controller 5 acquires the mean temperature value T from the temperature sensor 9 during the measurement of the mean voltage value V and the mean current value I. Then, the controller 5 performs a computation to correct the resistance value R at the average temperature T to the resistance value R₂₀ at 20° C. by the equation shown below.

R₂₀=R/[1+α₂₀(T−20)] (1)

Now in the equation (1) above, the resistance value R is computed from R=V/I at the temperature T, and α₂₀ is the resistance temperature coefficient at 20° C. By this means, the controller 5 acquires the internal resistance value R₂₀ of the battery cell 31 of the battery 3 at 20° C. Now the internal resistance value R₂₀ is one embodiment of the “internal resistance value” of the present invention.

Then the controller 5 determined the degree of progression of the fading of the battery cell 31 based on the internal resistance value R₂₀ of the battery cell 31 of the battery 3 at 20° C.

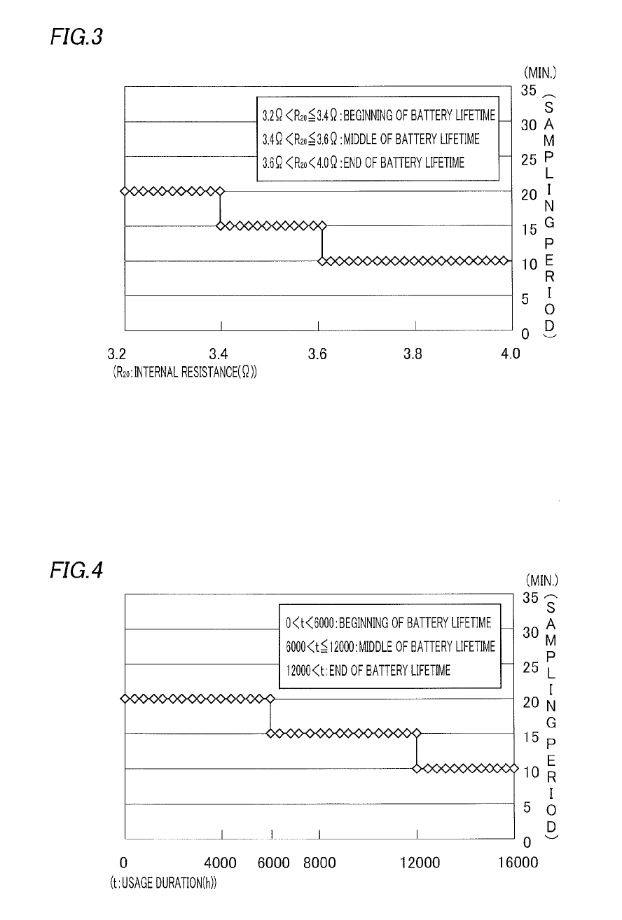

Specifically, as shown in FIG. 3, when the internal resistance R₂₀ is greater than 3.2Ω, and less than 3.4Ω, the controller 5 determines that the degree of progression of the fading condition of the battery cell 31 is in the beginning of the battery lifetime.

When the internal resistance R₂₀ is greater than 3.4Ω, and less than 3.6Ω, the controller 5 determines that the degree of progression of the fading condition of the battery cell 31 is in the middle of the battery lifetime.

When the internal resistance R₂₀ is greater than 3.6Ω, and less than 4.0Ω, the controller 5 determines that the degree of progression of the fade condition of the battery cell 31 is in the end of the battery lifetime.

When the controller 5 determines that the R₂₀ is an abnormal value, the degree of progression of the fade condition of the battery cell 31 is determined by computation of the usage duration of the battery 3 by a method described later. Specifically, when the internal resistance R₂₀ is less than 3.2Ω, or more than 4.0Ω, the controller 5 determines that the internal resistance R₂₀ is abnormal.

When the controller 5 determines that the internal resistance R₂₀ is abnormal, the usage duration of the battery 3 is computed. Specifically, by cumulating the duration of the performance of the charging and discharging of the battery cell 31 of the battery 3, the controller 5 computes the duration of usage t. Then, the controller 5 determines the degree of progression of the fading condition of the battery cell 31 based on the result of the computation of the duration of usage t.

Specifically, as shown in FIG. 4, when the usage duration t is greater than 0, and less than 6000 hours, the controller 5 determines that the degree of progression of the fading condition of the battery cell 31 is in the beginning of the battery lifetime.

When the usage duration t is greater than 6000 hours, and less than 12,000 hours, the controller 5 determines that the degree of progression of the fading condition of the battery cell 31 is in the middle of the battery lifetime.

When the usage duration t is greater than 12,000 hours, the controller 5 determines that the degree of progression of the fading condition of the battery cell 31 is in the end of the battery lifetime.

Next, the computation method of the target output value by the controller 5 in every battery lifetime of the battery 3 (battery cells 31) is explained while referring to FIG. 5.

In the beginning of the battery lifetime, the controller 5 computes the target output value from the mean value of 40 power output data samples (P(−40), P(−39), . . . P (−2), P (−1)) in the prior 20 minute sampling period. Specifically, the controller 5 sequentially accumulates power output data (P (−40), P (−39), . . . P (−2), P (−1)) in memory 5b. Then, the controller 5 computes the target output value (Q(0)=(P (−40)+P (−39), . . . +P (−2)+P (−1))/40) by dividing the latest 40 power output data sampling accumulated in memory 5b by 40. The controller 5 performs this computation of the target output value for each detection time interval (30 seconds). Then in order that the power output to the power grid 50 is the target output value, the controller 5 performs the control of the charge and discharge of the battery 3. By this means, the smoothing of the power output which is output from the supply section 4 to the power grid 50 is enabled.

In the middle of the battery lifetime, the controller 5 computes the target output value from the mean value of 30 power output data samples (P (−30), P (−29), . . . P (−2), P (−1)) in the prior 15 minute sampling period. Furthermore, in the end of the battery lifetime, the controller 5 computes the target output value from the mean value of 20 power output data samples (P (−20), P (−19), . . . P (−2), P (−1)) in the prior 10 minute sampling period.

Next, the control flow of the controller 5 when the determination of the degree of progression of the deteriorating condition of the battery 3 is being performed is explained while referring to FIGS. 2 to 4 and FIG. 7.

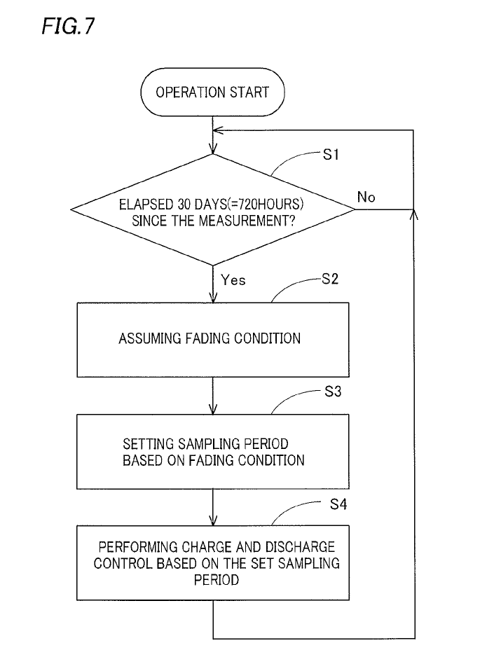

As shown in FIG. 7, in Step S1, a determination is reached by the controller 5 as to whether 30 days have elapsed since the measurement of the charge capacity and the discharge capacity of the battery cell 31 of the battery 3. Then this determination is repeated until 30 days have elapse since the measurement of the charge capacity and the discharge capacity of the battery cell 31 of the battery 3. Moreover, when a determination is reached by the controller 5 that 30 days have elapsed since the measurement of the charge capacity and the discharge capacity of the battery cell 31 of the battery 3, the system moves to Step S2.

Thereafter in Step S2, the controller 5 not only acquires the discharge capacity C_{d1} and the charge capacity C_{d2} of the battery cell 31, but computes the discharge capacity ratio C_{d1}/C₀₁ and the charge capacity ratio C_{d2}/C₀₂ of the battery cell 31, based on the discharge capacity C_{d1} and the charge capacity C_{d2}, and the discharge capacity C₀₁₂ and the charge capacity C₀₂ predetermined. As a result of this computation, as shown in FIG. 2, when discharge capacity ratio C_{d1}/C₀₁ and the charge capacity ratio C_{d2}/C₀₂ are greater than 0.85 and less than 1.0, it is estimated that the degree of the progression of the fading condition of the battery cell 31 is in the beginning of the battery lifetime. Moreover, when the discharge capacity ratio C_{d1}/C₀₁ and the charge capacity ratio C_{d2}/Cₒ₂ are greater than 0.70 and less than 0.85, it is estimated that the degree of the progression of the fading condition of the battery cell 31 is in the middle of the battery lifetime. Furthermore, when the discharge capacity ratio C_{d1}/C₀₁ and the charge capacity ratio C_{d2}/C₀₂ are greater than 0.40 and less than 0.70, it is estimated that the degree of the progression of the fading condition of the battery cell 31 is in the end of the battery lifetime.

Moreover, in Step S2, when the discharge capacity ratio C_{d1}/C₀₁ and the charge capacity ratio C_{d2}/C₀₂ are greater than 1.0, or when less than 0.40, a determination is enabled that the discharge capacity ratio C_{d1}/C₀₁ and the charge capacity ratio C_{d2}/C₀₂ are abnormal, and the mean voltage value V of battery cell 31, the mean current value I and the mean temperature T of the battery cell 31 are acquired, and the internal resistance R₂₀ can be computed based on the mean voltage value V, the mean current value I, and the mean temperature T. When the result of this computation, as shown in FIG. 3, reveals an internal resistance R₂₀ of greater than 3.2 and less than 3.4, an assumption is enabled that the lifetime of the battery cell 31 is in the beginning. Furthermore, when the result of this computation reveals an internal resistance R₂₀ of greater than 3.4 and less than 3.6, the assumption is enabled that the lifetime of the battery cell 31 is in the middle. When the result of this computation reveals an internal resistance R₂₀ of greater than 3.6 and less than 4.0, the assumption is enabled that the lifetime of the battery cell 31 is in the end.

Furthermore, in Step S2, when the internal resistance R₂₀ is less than 3.2, or greater than 4.0, a determination is enabled that the internal resistance R₂₀ is abnormal, and the fading condition of battery cell 31 can be estimated using the usage duration t of the battery 3. For example, as shown in FIG. 4, when the usage duration t is greater than 0, and less than 6000 hours, the assumption is enabled that the lifetime of the battery cell 31 is in the beginning period. Moreover, when the usage duration t is greater than 600 hours, and less than 12,000 hours, the assumption is enabled that the lifetime of the battery cell 31 is in the middle. Furthermore, when the usage duration t is greater than 12,000 hours, the assumption is enabled that the lifetime of the battery cell 31 is in the end.

Thereafter, in Step S3, the sampling period is set based on the results of the assumed fading condition of the battery cell 31. Specifically, in the event that the fading condition of the battery cell 31 of the battery 3 is assumed to be in the beginning of the battery lifetime, the sampling period is set at 20 minutes. Moreover, in the event that the fading condition of the battery cell 31 of the battery 3 is assumed to be in the middle of the battery lifetime, the sampling period is set at 15 minutes. Furthermore, in the event that the fading condition of the battery cell 31 of the battery 3 is assumed to be in the end of the battery lifetime, the sampling period is set at 10 minutes.

Thereafter, as shown in FIG. 7, in the Step S4, the charge and discharge control is performed based on the set sampling period.

The electricity generation system of this embodiment enables the derivation of the following benefits.

The controller 5 not only determines the fading condition of the battery 3, in accordance with the determined degree of progression of the fading condition, the acquisition period of the power output by the power generator 2 on the occasion of the computation of the target output value (sampling period) is made smaller. By means of the configuration described above, in the beginning of the battery lifetime of the battery cell 31 of the battery 3 where there is no fading, the sampling period is set long (approximately 20 minutes) on the occasion of the computation of the target output value. By this means, by the computation of the target output value based on a plenitude of power output data which was acquired in a longer set sampling period, the adverse impact on the incurred on the power grid 50 due to the fluctuation in the power output by the power generator 2 can be suppressed sufficiently. Moreover, in the end of the battery lifetime of the battery cell 31 of the battery 3 where the fading has progressed, because the sampling period is set shorter (approximately 10 minutes), on the occasion of the computation of the target output value, the difference from the target output value for the power output based on the small amount of power output data in the short-set sampling period can be made smaller. By this means, a lesser amount of charge and discharge by the battery 3 in order to fill-in the difference between the target output value and the amount generated is enabled. By this means, because the load on the battery cell 31 of the battery 3 in the end of the battery lifetime of the battery 3 can be made smaller, a contrivance at lengthening the lifetime of the battery cell 31 of the battery 3 is enabled. Therefore, in the present invention, a contrivance at lengthening the lifetime of battery 3 is enabled while suppressing the adverse impact of the fluctuation of the power output by the power generator 2 on the power grid 50.

Moreover, the controller 5 determines the fading condition of the battery 3 from any one of the discharge capacity C_{d1} and the charge capacity C_{d2} of the battery 3, the internal resistance R₂₀ of the battery cell 31 of the storage battery device 3 and the usage duration t of the battery 3. By means of the configuration described above, the determination of the fading condition of the battery cell 31 of the battery 3 is easily enabled based on any one of the discharge capacity C_{d1} and the charge capacity C_{d2}, the internal resistance R₂₀ and the usage duration t.

Moreover, in order to determine the fading condition of the battery 3, the controller 5 not only acquires the discharge capacity C_{d1} and the charge capacity C_{d2} of the battery 3, and the internal resistance R₂₀ for specific periods, by determining the degree of progression of the fading condition of the battery 3 based on the acquired results, the sampling period can be reduced. By acquiring the discharge capacity C_{d1} and the charge capacity C_{d2} of the battery 3, and the internal resistance R₂₀ for specific periods, because the fading condition of the battery cell 31 of the battery 3 can be determined, the setting of the length of the sampling period in each specific period can be updated.

Furthermore, the controller 5 determines the degree of progression of the fading condition of the battery 3 based on the computed results of the discharge capacity ratio C_{d1}/C₀₁ and the charge capacity ratio C_{d2}/C₀₂, and reduces the sampling period in correspondence with the determined degree of progression. The degree of progression of the fading condition of the battery 3 can be accurately determined from the computed discharge capacity ratio C_{d1}/C₀₁ and the charge capacity ratio C_{d2}/C₀₂. As a result, the sampling period can be reduced appropriately in correspondence with the degree of the progression of the fading condition determined.

Moreover, the controller 5 determines the degree of progression of the fading condition of the battery 3 based on the computed internal resistance R₂₀, and reduces the sampling period in correspondence with the determined degree of progression. In the event that the computed internal resistance R₂₀ rises, because a determination that the fading condition of the battery 3 has progressed is enabled, the degree of progression of the fading condition of the battery 3 can be accurately determined. As a result, the sampling period can be reduced appropriately in correspondence with the degree of the progression of the fading condition determined.

Furthermore, in the event that the controller 5 determines that the capacity of the battery 3 is abnormal, the fading condition of the battery 3 is determined from the internal resistance, and in addition, if the internal resistance of the battery 3 is determined to be abnormal, the fading condition of the battery 3 is determined from the usage duration of the battery 3. Also, in the event that either or both of the discharge capacity C_{d1} and the charge capacity C_{d2} of the battery 3, and the internal resistance R₂₀ are determined to be abnormal, the determination of the fading condition of the battery cell 31 of the battery 3 is enabled.

In addition, the controller 5 updates the sampling period stepwise in accordance with the fading condition of the battery 3. The appropriate updating of the sampling period in accordance with the fading condition of the storage battery device is enabled by updating the sampling period stepwise in accordance with the fading condition of the battery 3.

Moreover, the controller 5 modifies the sampling period to a period above the lower limit of the period T2 of the fluctuation period which enables correspondence with the load frequency control (LFC). By means of the configuration described above, even when the sampling period is modified in accordance with the fading condition of the battery 3, the reduction of the components of the fluctuation period enabling correspondence by the load frequency control (LFC) across the range of the lifetime of the battery cell 31 of the battery 3 from the beginning period to the end period is enabled.

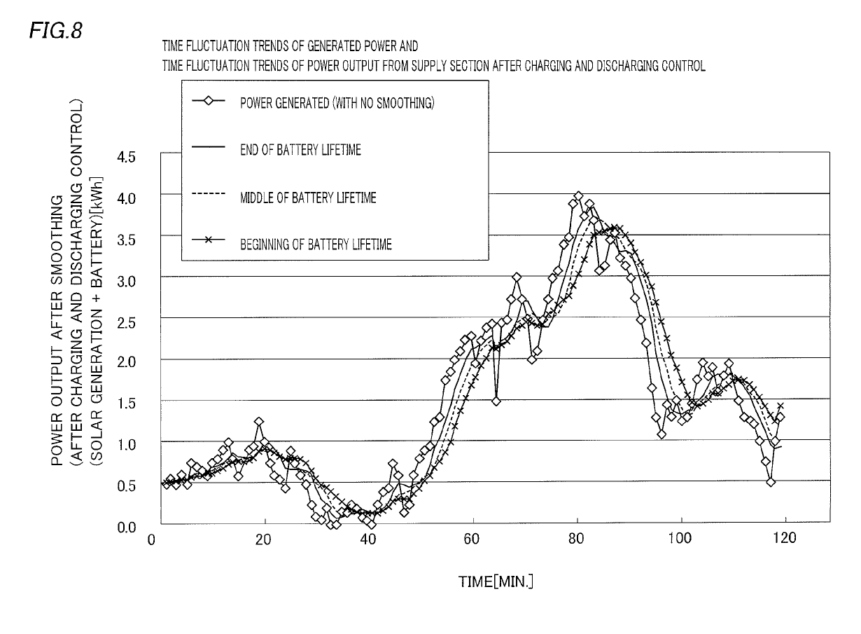

FIG. 8 shows a simulation of the time fluctuation trends of the power output which is generated from the power generator 2 (The power generated (with no smoothing)), and a simulation of the time fluctuation trends of the power output from the supply section 4 when charge and discharge are performed in respect of the power output from the power generator 2. Now, in relation to the power output from the supply section 4 when charging and discharging control is performed in respect of the power output from the power generator 2, three types of output power corresponding to each of the lifetime conditions (the beginning, the middle and the end of the battery lifetime) of the battery 3 (the battery cell 31) are represented.

As represented in FIG. 8, the time fluctuation trends of the power output from the power generator 2 has a greater fluctuation than the other time fluctuation trends. On the other hand, the time fluctuation trends of the power output from the supply section 4 in respect of the beginning, the middle and the end of the battery lifetime describe smooth curves. Therefore, it can be appreciated that the power output from the supply section 4 in beginning, the middle and the end of the battery lifetime are not only the result of the smoothing of the power output by the power generator 2, but was also output.

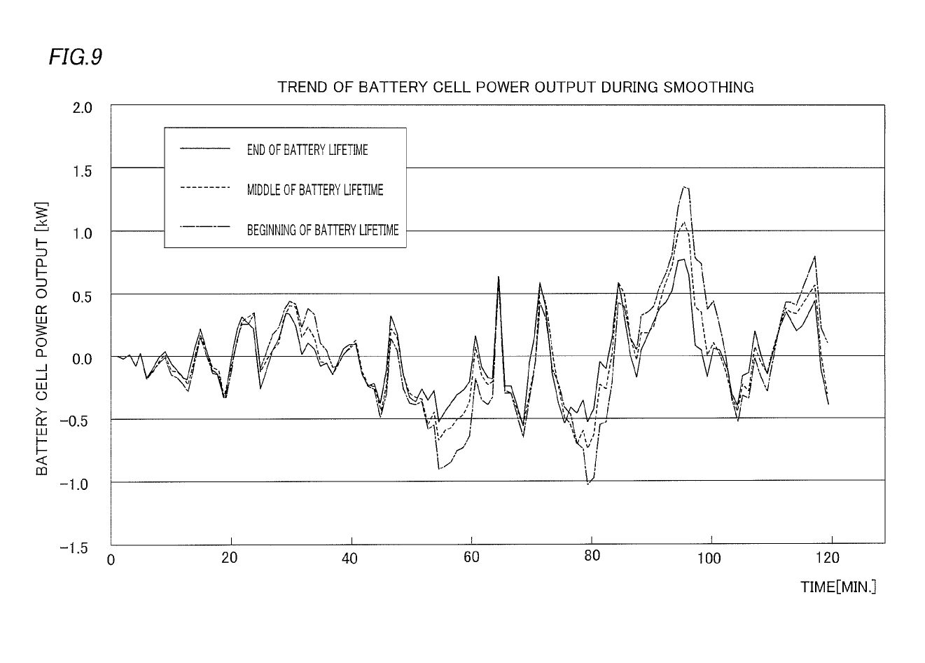

FIG. 9 shows a simulation of the results of the time fluctuation trends in the battery cell power output which was output from the battery cell 31. Now, FIG. 9 represents the battery cell power output for each of the lifetime stages of the battery cell 31 (the beginning, the middle and the end of the battery lifetime).

As shown in FIG. 9, on comparing the battery cell power output in the beginning of the battery lifetime with that of the middle of the battery lifetime and the end of the battery lifetime, the fluctuation is great. In other words, the absolute size of the values for the battery cell power output at any time, in most cases, those of the beginning of the battery lifetime are greater than those of the middle and the end of the battery lifetime. Therefore, it can be appreciated that the difference in the degree of maximal depth of the charge and discharge of the battery cell 31 lessens as the lifetime progresses from the beginning to the end of the battery lifetime.

Here, as the degree of maximal depth of the charge and discharge of the battery cell 31 lessens, the load on the battery cell 31 is lessened. Therefore, the degree of maximal depth of the charge and discharge of the battery cell 31 can be said to be greatly influenced by the lifetime of the battery cell. By the power generation system 1 of this embodiment, the load on the battery cell 31 can be lessened when the charge and discharge control is performed with the battery cell 31 in the middle through the end of the battery lifetime than in the beginning of the battery lifetime. By this means, when the battery cell 31 is in the middle through the end of the battery lifetime thereof, the suppression of the rapid fading of the battery cell 31 is enabled.

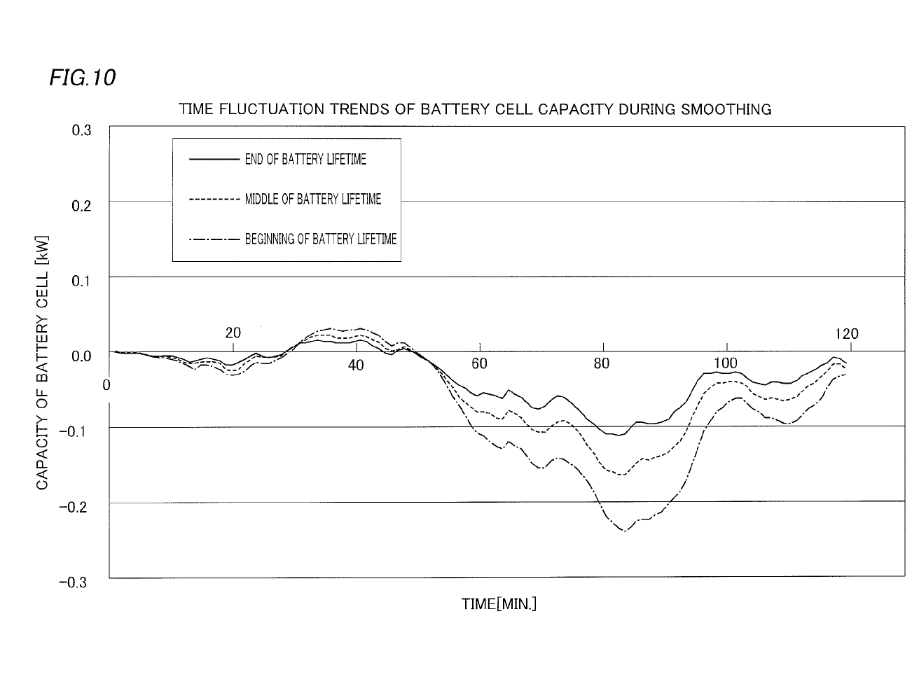

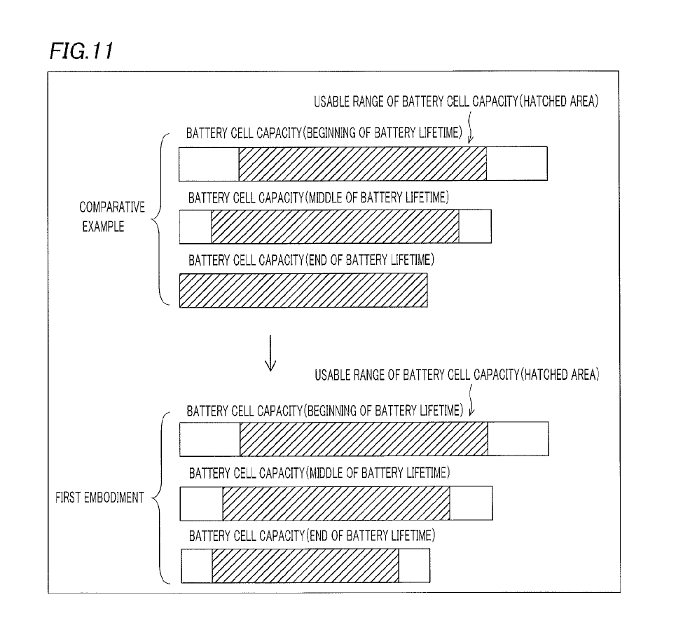

In addition, referring to FIG. 10 and FIG. 11, a simulation of the time fluctuation trends of the battery capacity of the battery cell 31 of the power generation system 1 is explained.

In FIG. 10, the battery capacity is shown for each of the three types of the battery cell capacity by the lifetime condition of the battery 3 (the beginning, the middle and the end of the battery lifetime).

As shown in FIG. 10, it can be appreciated that the absolute size of most of the parts of the battery cell capacity of the beginning of the battery lifetime at a certain time are greater than the size of the capacity of the battery cell in the middle and in the end of the battery lifetime thereof. In other words, it can be appreciated that the capacity of the battery cell 31 grows less on usage from the beginning to the end of the battery lifetime thereof.

As a result of the reduction in the capacity of the battery cell 31 on usage from the beginning to the end of the battery lifetime thereof, as shown in FIG. 11, the performance of the charging and discharging of the battery cell 31 is enabled in a range which is smaller than the capacity of the battery cell 31. By this means, because the load on the battery cell 31 can be lessened from the beginning to the end of the battery lifetime, the suppression of the rapid progress of the fading of the battery cell 31 is enabled.

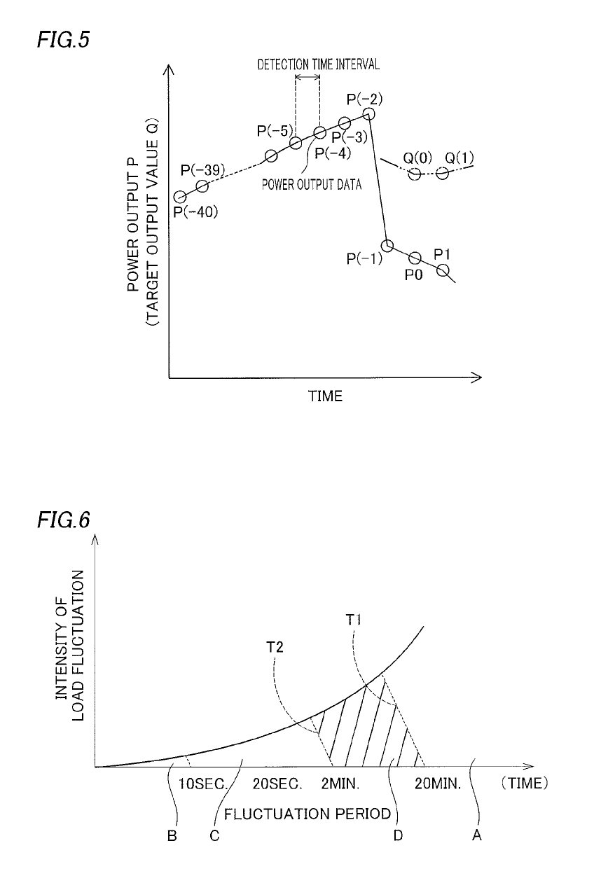

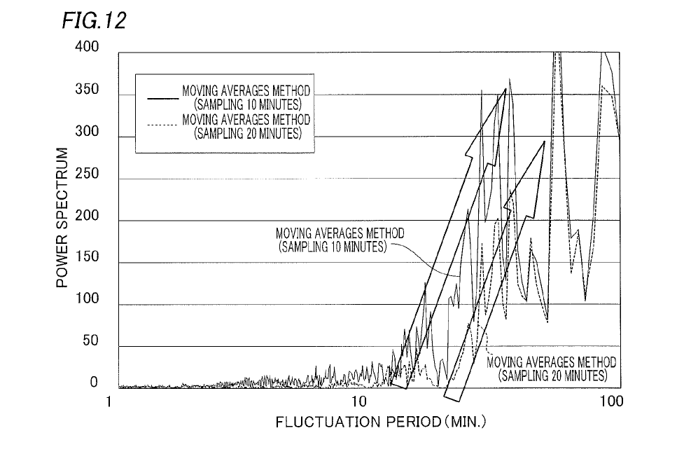

Next, the sampling period in the moving averages method in order to compute the target output value in this embodiment was investigated. Here, the results of the FFT analysis of the output power to the power grid when the sampling period which is the acquisition period of the power output data was 10 minutes, and the results of the FFT analysis of the output power to the power grid when the sampling period was 20 minutes are shown in FIG. 12. As shown in FIG. 12, it can be appreciated that when the sampling period was 10 minutes, while the fluctuation in respect of a range of up to 10 minutes of a fluctuation period could be suppressed, the fluctuation in a range of fluctuation periods which were greater than 10 minutes was not suppressed well. Moreover, when the sampling period was 20 minutes, while the fluctuation in respect of a range of up to 20 minutes of a fluctuation period could be suppressed, the fluctuation in a range of fluctuation periods which were greater than 20 minutes was not suppressed well. Therefore, it can be understood that there is a good mutual relationship between the size of the sampling period, and the fluctuation period which can be controlled by the charge and discharge control. For this reason, it can be said that by setting the sampling period the range of the fluctuation period which can be controlled effectively changes. In that respect, in order to suppress parts of the fluctuation period which can be addressed by the load frequency control which is the main focus of this system, it can be appreciated that it is preferable to sampling periods which are greater than the fluctuation period corresponding to the load frequency control, should be set, in particular, from the vicinity of the latter half of T1˜T2 (The vicinity of longer periods) to periods with a range of equal to or greater than T1. For example, in the example in FIG. 6, by utilizing a sampling period of greater than 20 minutes, it can be appreciated that suppression of most of the fluctuation periods corresponding to the load frequency control is enabled. However, when the sampling period is lengthened, there is a tendency for the required battery cell capacity to become greater, and it is preferable to select a sampling period which is not much longer than T1.

Now the embodiments and practical examples disclose here should be considered as mere examples and to not limit [the invention] in any way. The scope of the present invention, is represented by the scope of the patent claims and not by the embodiments explained above, in addition to all variants equivalent in meaning and range to the scope of the patent claims are included.

Moreover, in these embodiments, examples were represented using lithium ion batteries and Ni-MH batteries, but this invention is not limited to these, and other rechargeable batteries may be employed. Moreover, a capacitor may be employed instead of a battery cell as one example of the ‘battery cell’ of the present invention.

Furthermore, in these embodiments, the examples shown of the determination of the fading condition of the battery used the capacity of the battery, the internal resistance of the battery (battery cell) and the usage duration of the battery, but this invention is not limited to these. The determination of the fading condition of the battery may employ any one of the capacity of the battery, the internal resistance of the battery (battery cell) and the usage duration of the battery. Moreover, other parameters may be employed in the determination of the fading condition of the battery.

In this embodiment, the embodiment explained had the voltage of the battery cell 31 as 48 V, but this invention is not limited to this, and voltages other than 48 V may be employed. Now, the voltage of the battery cell is preferably less than 60 V.

Moreover, in this embodiment, an explanation was provided which did not consider the consumer power amount in the load used in the consumer residence, but the present invention is not limited to this. In the computation of the target output value, the controller may determine the amount of the electrical power consumption at least part of the loads that used in the consumer residence, and compute the target output value in consideration of the amount of the consumer power load or the fluctuation in the amount of power load consumed into account.

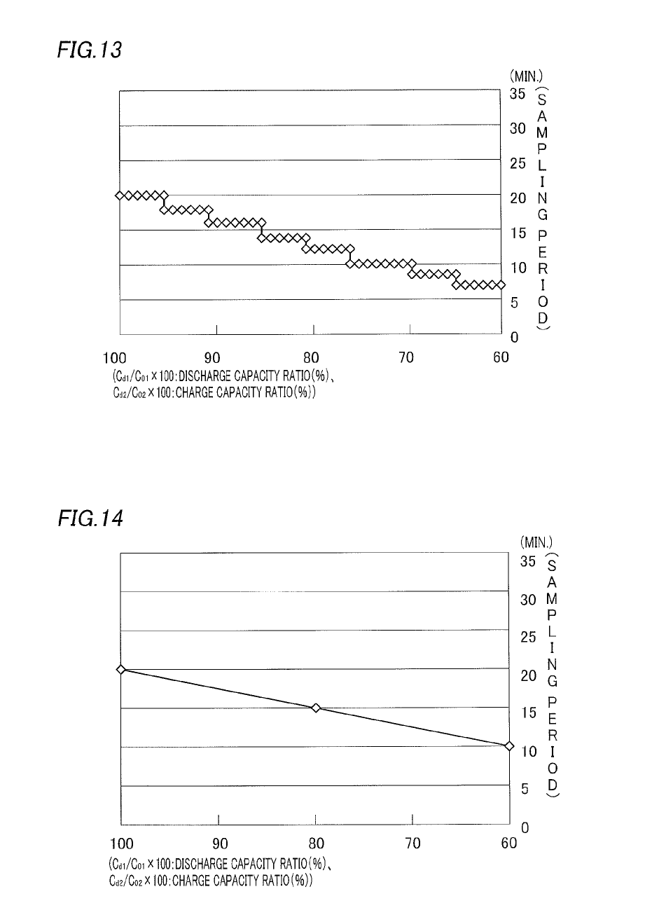

Furthermore, in the present embodiments, there were representations of embodiments where the sampling period was reduced stepwise in three stages in correspondence with the fading condition of the battery, but this invention is not limited to these. For example, as shown in the graph in FIG. 13, the sampling period can be reduced stepwise in multiple stages which are more than three stages, and as shown in the Graph in FIG. 14, the sampling period may be reduced linearly.

Moreover, in the present embodiments, the charge and discharge control was performed all of the time, but a configuration may be employed such that in the event that a determination is made that the difference between the target output value and the power output by the power generator 2 is less than 5%, the charging and discharging of the battery 3 may be suspended. Furthermore, a configuration wherein the charging and discharging control are performed limited to when the power output by the power generator 2 is above a specific power output, in addition to when the fluctuation amount in the power output is greater than a specific fluctuation may also be enabled. By this means, a reduction in the number of charging and discharging events is enabled, and an attempt to lengthen the lifetime of the battery 3 is enabled.

What is claimed is:

1. A method of controlling a power generator generating electric power using renewable energy and a battery storing electric power generated by the power generator, comprising:
acquiring data on an amount of electric power generated by the power generator at predetermined time intervals over a sampling period, the data being acquired as electric signals;
computing a target output value for the electric power to be supplied to an electric power transmission system based on the data on the amount of electric power generated by the power generator;
supplying to the electric power transmission system electric power equal to the target output value from at least one of the power generator and the battery;
determining a fading condition of the battery; and
varying the sampling period in accordance with the fading condition of the battery.

2. The method of claim 1, wherein the sampling period is made shorter as fading of the battery progresses.

3. The method of claim 1, wherein the sampling period is modified stepwise in accordance with the progress of the fading of the battery.

4. The method of claim 1, wherein the fading condition of the battery is determined based on a capacity of the battery, an internal resistance of the battery, or an usage duration of the battery.

5. The method of claim 4, wherein the fading condition of the battery is determined based on a first capacity value acquired by measuring a capacity of the battery during one or more measurement periods and a second capacity value corresponding to an initial measured capacity of the battery.

6. The method of claim 5, wherein the fading condition of the battery is determined based on a capacity ratio calculated by dividing the first capacity value by the second capacity value.

7. The method of claim 4, wherein the fading condition of the battery is determined based on measuring a voltage, current, and temperature of the battery during one or more measurement periods and calculating an internal resistance value of the battery.

8. The method of claim 4, wherein the fading condition is determined based on a usage duration of the battery calculated by adding together a duration of charging of the battery and a duration of discharging of the battery that have occurred over a lifetime of the battery.

9. The method of claim 4, wherein the fading condition of the battery is determined based on the internal resistance of the battery if the capacity of the battery is determined to be abnormal, and the fading condition of the battery is determined based on the usage duration of the battery if the internal resistance of the battery is determined to be abnormal.

10. A computer-readable recording medium which records a control program for causing one or more computers to perform the steps comprising:
acquiring data on an amount of electric power generated by a power generator at predetermined time intervals over a sampling period;
computing a target output value for the electric power to be supplied to an electric power transmission system based on the data on the amount of electric power generated by the power generator;
supplying to the electric power transmission system electric power equal to the target output value from at least one of the power generator and a battery storing electric power generated by the power generator;
determining a fading condition of the battery; and
varying the sampling period in accordance with the fading condition of the battery.

11. An electric power generation system, comprising:
a power generator configured to generate electric power using renewable energy;
a battery configured to store electric power generated by the power generator; and
a controller configured such that electric power is supplied to an electric power transmission system from at least one of the power generator and the battery, to compute a target output value for the electric power to be supplied to the electric power transmission system based on data on an amount of power generated by the power generator over a sampling period, to determine a fading condition of the battery, and to modify the sampling period in accordance with the determined fading condition.

12. An electric power generation system, comprising:
a power generator configured to generate electric power using renewable energy;
a battery configured to store electric power generated by the power generator; and
a supply section configured to supply electric power to an electric power transmission system from at least one of the power generator and the battery;
a commutation section configured to compute a target output value for the electric power to be supplied through the supply section to the electric power transmission system based on data on an amount of power generated by the power generator over a sampling period; and
a sample period modification section configured to modify the sampling period based on a fading condition of the battery.

13. A device controlling a power generator generating electric power using renewable energy and a battery storing electric power generated by the power generator, comprising:
a data acquisition part configured to acquire data on an amount of electric power generated by the power generator at predetermined time intervals over a sampling period;
a computation part configured to compute a target output value for the electric power to be supplied to an electric power transmission system based on the data on the amount of electric power generated by the power generator;
a sample period modification part configured to modify the sampling period based on a fading condition of the battery; and
a supply control part configured to have at least one of the power generator and the battery supply electric power equal to the target output to the electric power transmission system.
